(19) United States
(12) Patent Application Publication
(10) Pub. No.: US 2010/0274875 A1
(43) Pub. Date: Oct. 28, 2010

(54) INFORMATION PROCESSING APPARATUS AND FILE DISTRIBUTION METHOD

(76) Inventors: Kozo Banno, Kawasaki-shi (JP); Koichiro Kamura, Fujisawa-shi (JP); Hitoshi Oitaira, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/708,457

(22) Filed: Feb. 18, 2010

(30) Foreign Application Priority Data
Apr. 28, 2009 (JP) 2009-109800

(51) Int. Cl. G06F 15/16; G06F 15/177

(52) U.S. Cl. 709/219; 709/220

(57) ABSTRACT

According to one embodiment, an information processing apparatus includes a setting module configured to set each of plurality of computers in a data receivable state based on a address information read from a storage module, a reception module configured to receive, from each of the plurality of computers set in the data receivable state by the setting module, a data reception ready notification which is transmitted over the network by multicasting to notify data reception ready, and a transmission module configured to, when the reception module has received the data reception ready notification from each of the plurality of computers, transmit, by multicasting, the data read from the storage module and to be used to install the common system environment to the computers on the network from which the data reception ready notifications have been received.

### CROSS-REFERENCE TO RELATED APPLICATIONS

This application is based upon and claims the benefit of priority from Japanese Patent Application No. 2009-109800, filed Apr. 28, 2009, the entire contents of which are incorporated herein by reference.

### BACKGROUND

1. Field

One embodiment of the present invention relates to an information processing apparatus and a file distribution method which allow, by remote control, software installation on a computer connected to a network.

2. Description of the Related Art

Various techniques for managing a plurality of computers connected to a network have been put into practical use. Examples are a technique called wakeup-on-LAN (WOL), which powers up a computer on a network by remote control; a technique called Preboot Execution Environment (PXE), which causes a diskless machine on a network to perform a network boot; a technique called multicast transmission, which simultaneously transmits identical data to a plurality of computers grouped in advance on a network; and a technique of copying data to a server apparatus on a network by remote control. These techniques also allow an operating system (OS) to be installed on another computer connected to the network.

Each computer to be powered up by remote control based on WOL comprises a communication apparatus powered by a constantly available power supply. This communication apparatus is assigned a media access control (MAC) address in advance. A server apparatus which powers up the plurality of computers connected to the network stores the MAC addresses. In accordance with the MAC addresses, the server apparatus accesses the plurality of computers connected to the network. Similarly, each computer stores the MAC address of the server apparatus and transmits data to it in accordance with the MAC address when, e.g., returning a response to the server apparatus. In this case, a Dynamic Host Configuration Protocol (DHCP) server or the like assigns IP addresses so that data transmission/reception processing is performed based on the IP addresses.

To execute the multicast transmission to a plurality of computers belonging to a specific group, the server apparatus performs the following processing. For example, on a Transmission Control Protocol/Internet Protocol (TCP/IP) network, the server apparatus presets one of class D IP addresses (224.0.0.0 to 239.255.255.255) that allow the multicast transmission as a multicast group address to be commonly recognized by a plurality of server apparatuses belonging to the specific group. To simultaneously transmit data to the plurality of computers belonging to the specific group, the server apparatus transmits the data to the multicast group address. For example, Jpn. Pat. Appln. KOKAI Publication No. 2003-44288 discloses a technique of causing a server apparatus to install an operating system on a plurality of computers connected to a network.

In Jpn. Pat. Appln. KOKAI Publication No. 2003-44288, however, to cause the plurality of computers connected to the network to access the server apparatus, the IP address of the server apparatus needs to be stored in the DHCP server in advance. This makes the operation cumbersome.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view schematically showing an exemplary arrangement of a file distribution system using a distribution server according to an embodiment of the present invention;

FIG. 2 is an exemplary block diagram schematically showing an exemplary functional arrangement of the distribution server;

FIG. 3 is an exemplary view showing an exemplary concept of various data stored in an HDD;

FIG. 4 is an exemplary block diagram showing an exemplary functional arrangement of a file distribution application;

FIG. 5 is an exemplary view showing an exemplary concept of the system configuration of a client;

FIG. 6 is an exemplary view showing an exemplary structure of a file distributed from the distribution server to the clients and an exemplary concept of response signals transmitted from the clients to the distribution server;

FIG. 7 is an exemplary view showing an exemplary concept of the structure of a response signal transmitted from a client to the distribution server;

FIG. 8 is an exemplary view schematically showing an exemplary arrangement of a file distribution system whose file distribution target is limited to a single subnet;

FIG. 9 is an exemplary sequence chart showing an exemplary procedure of the processing for registering the MAC addresses of clients at the installation data distribution destinations and the processing for receiving the installation data;

FIG. 10 is an exemplary sequence chart showing an exemplary procedure of file distribution processing;

FIG. 11 is an exemplary view schematically showing an exemplary arrangement of a file distribution system using a distribution server according to an embodiment of the present invention; and

FIG. 12 is an exemplary sequence chart showing an exemplary procedure of file distribution processing using a distribution server according to a modification of the embodiment.

### DETAILED DESCRIPTION

Various embodiments according to the invention will be described hereinafter with reference to the accompanying drawings. In general, according to one embodiment of the invention, an information processing apparatus includes: a storage module configured to store address information of a plurality of computers, on a network, on which a common system environment is to be installed and data to be used to install the common system environment; a setting module configured to set each of the plurality of computers in a data receivable state based on the address information read from the storage module; a reception module configured to receive, from each of the plurality of computers set in the data receivable state by the setting module, a data reception ready notification which is transmitted over the network by multicasting to notify data reception ready; and a transmission module configured to, when the reception module has received the data reception ready notification from each of the plurality of computers, transmit, by multicasting, the data read from the storage module and to be used to install the common system environment to the computers on the network from which the data reception ready notifications have been received.

An embodiment of the present invention will now be described with reference to the accompanying drawing.

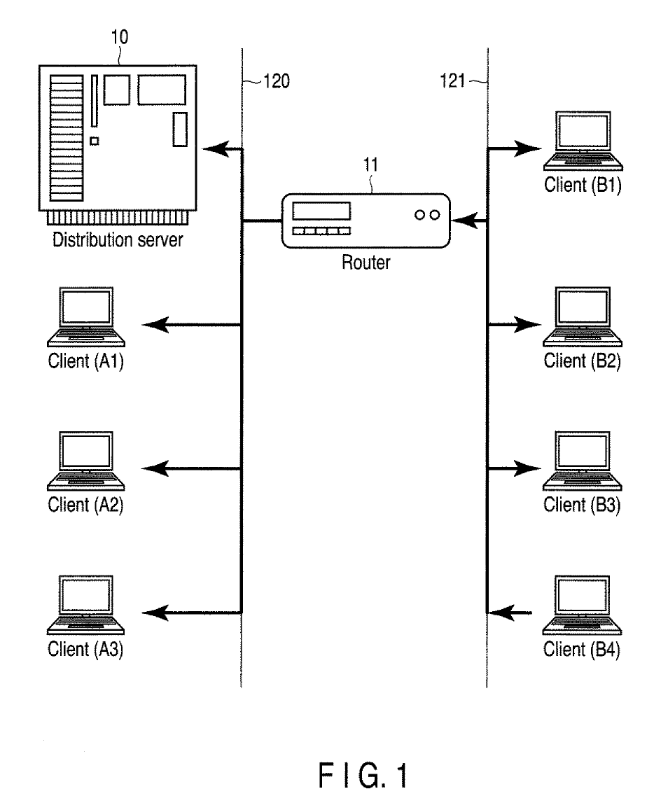

The arrangement of a file distribution system using an information processing apparatus according to an embodiment of the present invention will be described first with reference to FIG. 1. The information processing apparatus is implemented as, e.g., a distribution server 10.

FIG. 1 is a view schematically showing the arrangement a file distribution system using the distribution server 10.

The file distribution system comprises the distribution server 10, a router 11, clients (computers) A1 to A3, and clients (computers) B1 to B4. The distribution server 10 has a function of receiving, as installation image data via a network 120, the system data of the operating system which has been updated to the latest version in, e.g., client A1, a function of storing the MAC addresses of the clients (e.g., clients A2, A3, and B1 to B4) connected to the network 120, a function of transmitting an activation request signal to each client in accordance with the stored MAC address, and a function of receiving an activation completion signal from each client, and the like. Client A1 updates the operating system installed on it to the latest version. Client A1 transmits the system data to the distribution server 10 in response to a request from it. Each of clients A2, A3, and B1 to B4 has a function of activating the system in response to the activation request signal from the distribution server 10 and sending the activation completion signal over the networks 120 and 121 by multicasting. The router 11 has a function of interconnecting the networks 120 and 121, and the like.

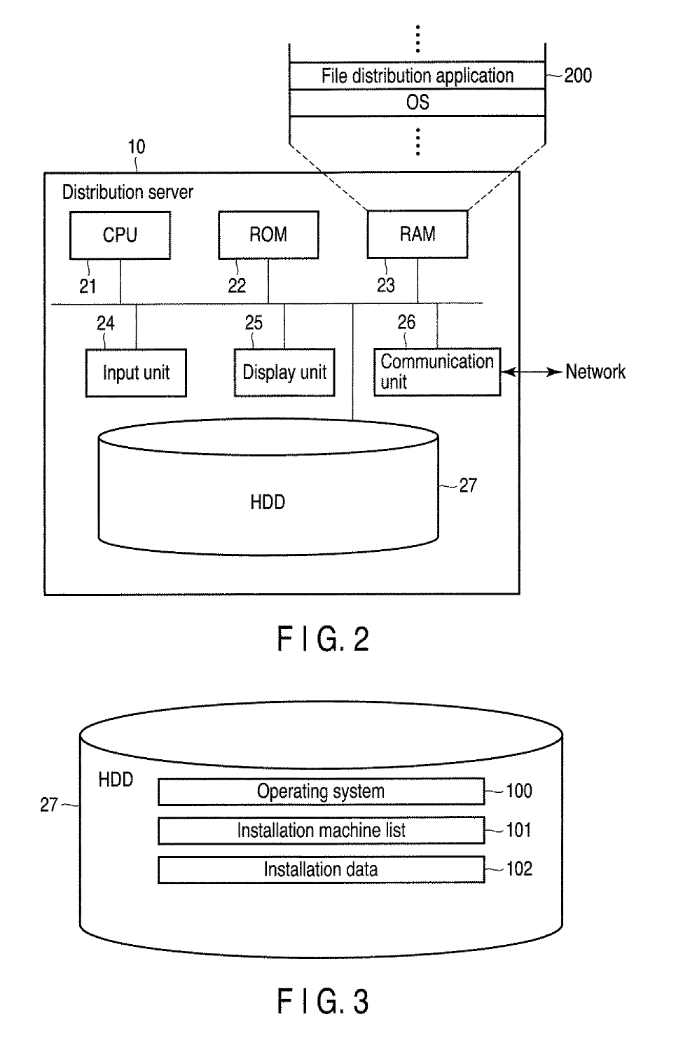

FIG. 2 is a block diagram schematically showing the functional arrangement of the distribution server 10.

The distribution server 10 includes a CPU 21, ROM 22, RAM 23, input unit 24, display unit 25, communication unit 26, and hard disk drive (HDD) 27 serving as a storage module. These units are connected to each other via a bus 30. The communication unit 26 is connected to the network 120.

The central processing unit (CPU) 21 reads main control programs (operating system 100: FIG. 3), system programs, and various kinds of application programs stored in the ROM 22 and the HOD 27. The CPU 21 loads the read programs into a memory area (not shown) in the RAM 23 together with, e.g., various kinds of instruction data input via the input unit 24.

Based on the instruction data or the like, the CPU 21 executes various processes in accordance with the various programs loaded into the memory area. The CPU 21 stores the processing result in the memory area and also displays it on the display unit 25.

The CPU 21 reads client information containing a MAC address one by one from an installation machine list 101 stored in the HDD 27 shown in FIG. 3. Based on the read client information, the CPU 21 sequentially transmits power-up packets to all client hosts registered in the installation machine list 101 by the WOL function. With this operation, for example, clients A2, A3, and B1 to B4 are powered up. The CPU 21 then transits to a reception state so as to be able to receive a data reception ready notification from clients A2, A3, and B1 to B4 that have been powered up.

The CPU 21 receives a data reception ready notification (a signal which notifies that a client is ready for reception of installation data 102 by multicast transmission) from each of clients A2, A3, and B1 to B4. The CPU 21 sends a connection request to a client on the networks 120 and 121 from which the CPU has received the data reception ready notification, thereby establishing connection. The CPU 21 compares the MAC address information of the transmission source of the received data reception ready notification with that of the client on the networks 120 and 121 which has established the connection. If the two pieces of MAC address information coincide with each other upon comparison, the CPU 21 transmits the installation data (data to install a common system environment) 102 to the client on the networks 120 and 121 which has established the connection.

The input unit 24 is formed from a keyboard including cursor keys, number input keys, various function keys, and the like or a pointing device such as a mouse, tablet, or touchpad. The input unit 24 outputs, to the CPU 21, the press signal of a key pressed on the keyboard or an operation signal input by the pointing device such as a mouse.

The ROM 22 is formed from a semiconductor memory such as a flash memory or electrically erasable programmable read-only memory (EEPROM) and stores main control programs such as a BIOS program and boot code.

The RAM 23 holds various kinds of programs (operating system, system programs, and various application programs) to be executed by the CPU 21. The RAM 23 has a memory area to temporarily store, e.g., instruction data input via the input unit 24 and various processing results during program execution.

The display unit 25 has a display screen such as a cathode ray tube (CRT) or a liquid crystal display (LCD). The display unit 25 performs display on the display screen in accordance with various display signals output from the CPU 21. The various display signals include various data input via the input unit 24, various data loaded from the computers on the network, and various data stored in the ROM 22, RAM 23, and HDD 27.

The communication unit 26 comprises, e.g., a LAN card having a function for network connection to the plurality of computers on the networks 120 and 121. The communication unit 26 may also comprise an antenna, modulation/demodulation circuit, and encoding/decoding circuit. In this case, network connection by wireless communication is possible.

The hard disk drive (HDD) 27 stores various data files of the operating system 100, installation machine list 101, installation data 102, and the like.

The operating system is a system program to control the distribution server 10. The installation machine list 101 represents client information that records the MAC addresses of a plurality of clients on which software such as an operating system is to be installed by remote control. In correspondence with each client, the client information records, e.g., a client name, MAC address, and flag data representing whether installation has been completed.

The installation data 102 is data to be transmitted to a client host and installed. Upon receiving the installation data, the client installs it in the HDD and transmits a completion notification to the distribution server 10. For example, as shown in FIG. 6, DATA (installation data 102) is divided into a plurality of blocks (block=1, 2, . . . ) and distributed. For example, when block=1 is distributed, the distribution server 10 receives an OK command representing completion of data reception from each of clients A2, A3, and B1 to B4. After receiving the OK commands from clients A2, A3, and B1 to B4, the distribution server 10 starts distributing block=2. For example, as shown in FIG. 7, the OK command includes a destination address (DA) representing the address of the destination (distribution server 10), a source address (SA) representing the address of the transmission source, an Internet Protocol (IP) header, a User Datagram Protocol (UDP) header, and a client OK (reception completion) response.

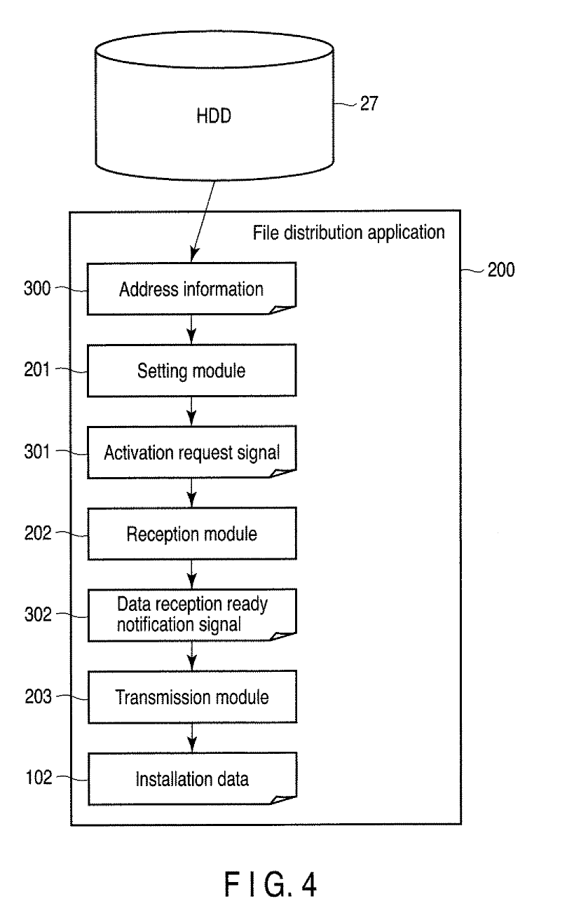

FIG. 4 is a block diagram showing the functional arrangement of a file distribution application 200.

The file distribution application 200 comprises a setting module 201, reception module 202, and transmission module 203.

The setting module 201 reads the installation machine list 101 stored in the HDD 27. The setting module 201 thus acquires address information 300 of the MAC addresses of clients as a batch installation target. Based on the acquired address information 300, the setting module 201 transmits an activation request signal to, e.g., clients A2, A3, and B1 to B4. Each of clients A2, A3, and B1 to B4 which have received the activation request signal transmits a data reception ready notification to the distribution server 10 by multicasting. In this case, clients A2, A3, and B1 to B4 use the multicasting to transmit the data reception ready notification to the distribution server 10. Hence, clients A2, A3, and B1 to B4 need not retain the MAC address or the like of the distribution server 10. More specifically, the distribution server 10 need not set a fixed MAC address either. The distribution server 10 can be connected to the network 120 as needed to distribute a file to clients A2, A3, and B1 to B4. Once the reception module 202 has received a data reception ready notification (reception ready notification signal) 302 from each of clients A2, A3, and B1 to 54, the transmission module 203 transmits the installation data 102 to clients A2, A3, and B1 to B4.

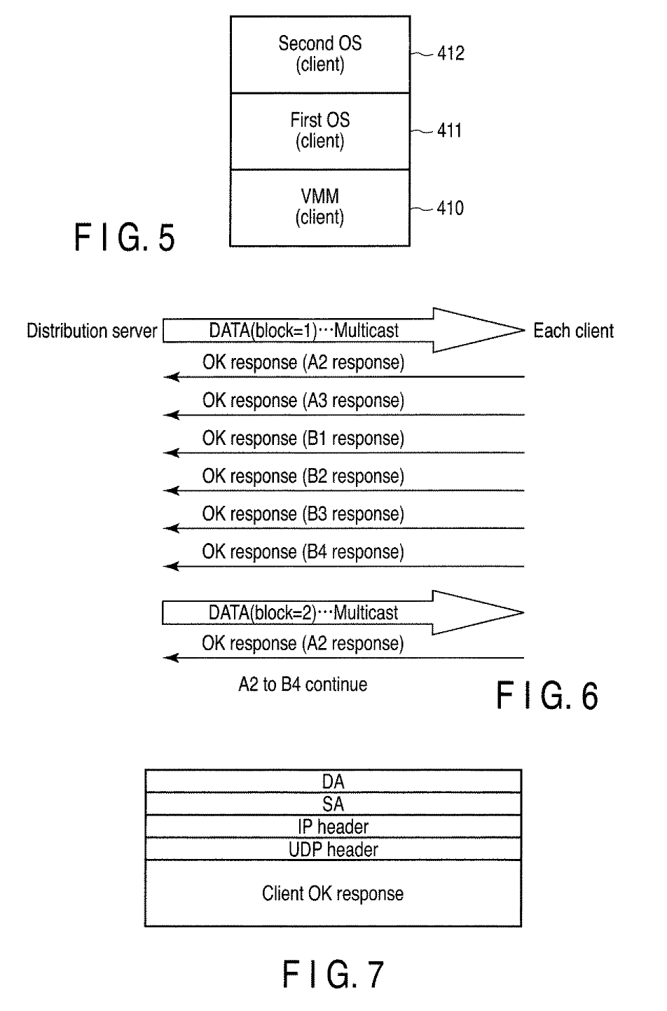

FIG. 5 is a view showing the system configuration of each of clients A1 to A3 and B1 to B4. As shown in FIG. 5, each of clients A1 to A3 and B1 to B4 includes a VMM 410, first OS 411, and second OS 412. Out of clients A1 to A3 and B1, for example, client A1 is set as an initial update client. Client A1 performs processing for updating the second OS to the latest version. This processing can be done by client A1 periodically or in response to a request from the distribution server 10. The processing may be done in both modes. That is, client A1 may update the second OS to the latest version by itself and also upon receiving a request from the distribution server 10.

After the second OS in client A1 has been updated, the distribution server 10 copies the second OS from client A1 and receives it as the installation data 102. The distribution server 10 stores the received installation data 102 in the HDD 27. The distribution server 10 distributes the installation data 102 stored in the HOD 27 to clients A2, A3, and B1 to 84, as described above.

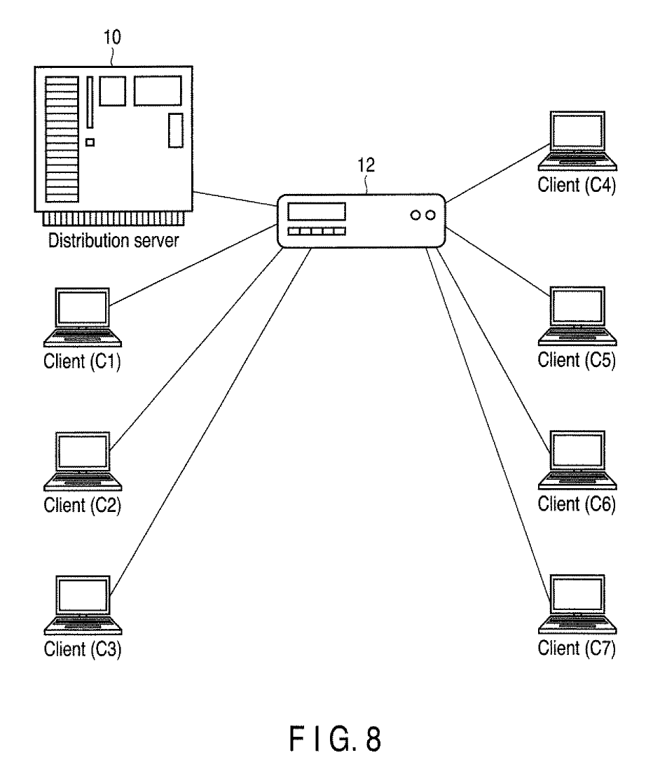

Note that the file distribution system according to the embodiment of the present invention may have, e.g., an arrangement shown in FIG. 8. In this form, the file distribution target is limited to a single subnet. In this case, the distribution server 10 distributes the installation data 102 to clients C2 to C7 using a hub 12 in place of the router 11. For example, a client C1 is similarly set as an initial update client.

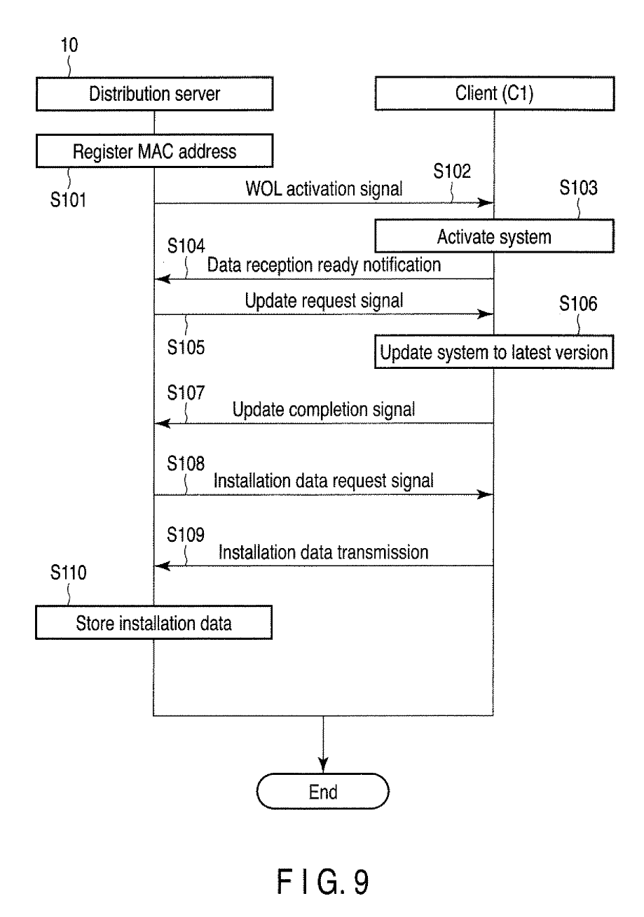

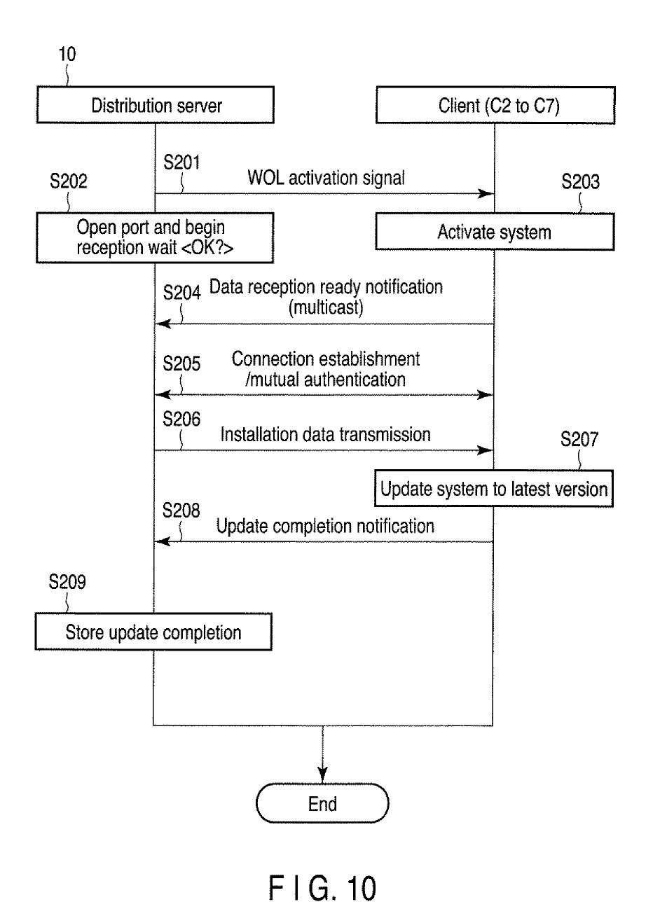

The procedure of file distribution processing by the file distribution system having the above arrangement will be explained with reference to the sequence charts of FIGS. 9 and 10. Note that in the following description, the file distribution system uses the arrangement shown in FIG. 8, and client C1 is used as the initial update client. However, any other client may be set as the initial update client.

Processing for registering the MAC addresses of clients C2 to C7 at the distribution destinations of the installation data 102 and processing for receiving the installation data 102 will be described with reference to FIG. 9.

The distribution server 10 registers MAC addresses and the like in the HOD 27 as the installation machine list 101 representing the information of clients of the installation destinations of the installation data 102 (block S101). The distribution server 10 transmits a WOL activation signal (activation request signal) to client C1 that is the initial update client (block S102).

Client C1 activates the system in response to the WOL activation signal (activation request signal) (block S103). Once system activation has ended, client C1 transmits a data reception ready signal to the distribution server 10 (block S104). Upon receiving the data reception ready signal, the distribution server 10 transmits an update request signal (a signal to update the operating system of client C1 to the latest version) to client C1 (block S105). Client C1 receives the update request signal and updates its system to the latest version (block S106). After updating the system to the latest version, client C1 transmits an update completion notification to the distribution server 10 (block S107). Upon receiving the update completion notification, the distribution server 10 transmits an installation data request signal to client C1 (block S108). Client C1 receives the installation data request signal and transmits its operating system to the distribution server 10 as installation data (block S109). The distribution server 10 receives the installation data and stores it in the HDD 27 (block S110).

The processing for registering the MAC addresses of clients C2 to C7 at the distribution destinations of the installation data 102 and the processing for receiving the installation data 102 are thus ended.

File distribution processing will be explained next with reference to FIG. 10. Based on the registered MAC addresses, the distribution server 10 transmits a WOL activation signal (activation request signal) to clients C2 to C7 of the file distribution destinations (block S201). After transmitting the WOL activation signal to clients C2 to C7, the distribution server 10 opens the reception port to wait for reception of a data reception ready signal transmitted from each of clients C2 to C7 by multicasting (block S202). Upon receiving the WOL activation signal, each of clients C2 to C7 activates the system in response to the received WOL activation signal (block S203). Once system activation has ended, each of clients C2 to C7 transmits a data reception ready signal to the distribution server 10 by multicasting (block S204). Transmitting the data reception ready signal to the distribution server 10 by multicasting allows each of clients C2 to C7 to transmit the data reception ready signal to the distribution server 10 without referring to its MAC address or the like. Upon receiving the data reception ready signal, the distribution server 10 establishes connection to each of clients C2 to C7 and performs mutual authentication (block S205). After establishing connection to clients C2 to C7 and performing mutual authentication, the distribution server 10 transmits the installation data 102 stored in the HDD 27 to each of clients C2 to C7 (block S206). Each of clients C2 to C7 receives the installation data 102 and updates its operating system to the latest version using the installation data 102 (block S207). After updating the operating system, each of clients C2 to C7 transmits an update completion notification to the distribution server 10 (block 5208). Upon receiving the update completion notification, the distribution server 10 stores the update completion in the HDD 27 or the like (block 5209).

It is an object of the present invention to provide an information processing apparatus and a file distribution method which allow a server apparatus of a file distribution source to distribute installation data to each computer without storing the address of the server apparatus in the installation target computer or a DHCP server.

According to the above-described embodiment, each of clients C2 to C7 transmits the data reception ready signal to the distribution server 10 by multicasting. This allows clients C2 to C7 to transmit the data reception ready signal to the distribution server 10 without referring to its MAC address or the like. More specifically, the distribution server 10 of the file distribution source can distribute the installation data 102 without storing the address of the distribution server 10 on the installation target computer.

Namely, it is possible to cause a server apparatus of a file distribution source to distribute a file by multicasting without storing the address of the server apparatus on the installation target computer or a DROP server.

A modification of the embodiment will be described next.

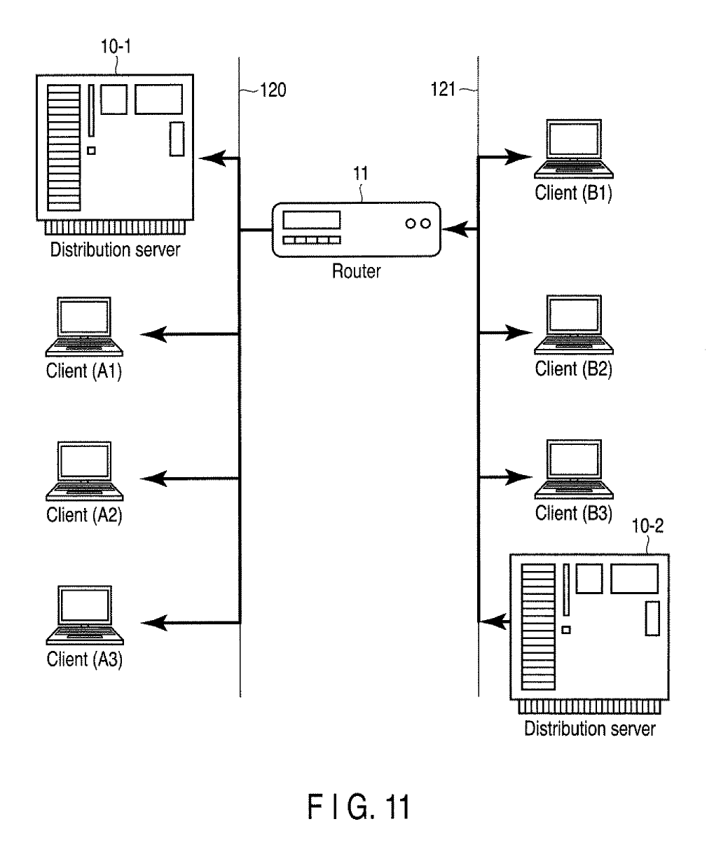

In the above-described embodiment, one distribution server is used. However, a plurality distribution servers may exist. An example in which two distribution servers 10-1 and 10-2 exist, as shown in FIG. 11, will be described.

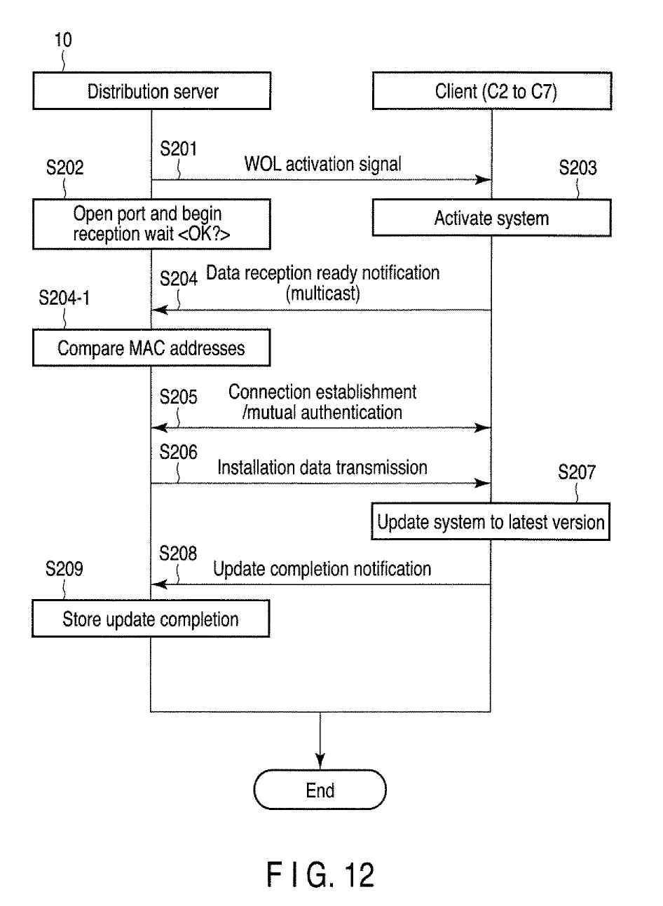

In this modification, there are the two distribution servers 10-1 and 10-2. Hence, the installation machine list representing the distribution destinations of the installation data 102 is divided into two parts without overlap and stored in the distribution servers 10-1 and 10-2. In the file distribution processing, a process of comparing MAC addresses (block S204-1) is added, as shown in FIG. 12. This process is executed to determine which of the distribution servers 10-1 and 10-2 has transmitted a WOL activation signal (activation request signal) received by a client. More specifically, to transmit data, by multicasting, to a client which has established connection, the MAC address of the transmission source of the data reception ready notification is compared with that of the client which has established the connection. If the MAC addresses coincide with each other upon comparison processing, the distribution server transmits the installation data 102 to the client which has established the connection. This comparison processing makes it possible to support a file distribution system including a plurality of distribution servers. In addition, arranging a plurality of distribution servers allows the load on each distribution server to be reduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The information processing apparatus of the embodiment is not limited to the computer but can also be realized by various information processing apparatuses such as a personal digital assistant (PDA). A module can be implemented in software or hardware. In addition, the application program is stored storage medium. A module can be accomplished in software and hardware.

What is claimed is:

1. An information processing apparatus comprising:
a storage module configured to store address information of a plurality of computers, on a network, on which a common system environment is to be installed and data to be used to install the common system environment;
a setting module configured to set each of the plurality of computers in a data receivable state based on the address information read from the storage module;
a reception module configured to receive, from each of the plurality of computers set in the data receivable state by the setting module, a data reception ready notification which is transmitted over the network by multicasting to notify data reception ready; and
a transmission module configured to, when the reception module has received the data reception ready notification from each of the plurality of computers, transmit, by multicasting, the data read from the storage module and to be used to install the common system environment to the computers on the network from which the data reception ready notifications have been received.

2. The apparatus of claim 1, wherein after the setting module has set each of the plurality of computers in the data receivable state, a reception state to receive the data reception ready notification is set.

3. The apparatus of claim 1, wherein when the reception module has received the data reception ready notification from each of the plurality of computers, a connection request is sent to the computers on the network from which the data reception ready notifications have been received, and after establishing connection, the data read from the storage module and to be used to install the common system environment is transmitted to the computers on the network which have established the connection.

4. The apparatus of claim 3, wherein when transmitting, by multicasting, the data read from the storage module and to be used to install the common system environment to the computers on the network which have established the connection, address information of a transmission source of the received data reception ready notification is compared with the address information of each of the computers on the network which have established the connection, and if the pieces of address information coincide with each other, the data to be used to install the common system environment is transmitted to the computers on the network which have established the connection.

5. The apparatus of claim 1, wherein when transmitting the data read from the storage module and to be used to install the common system environment to the computers on the network which have established the connection, the data is transmitted to the computers by multicasting.

6. A file distribution method used by an information processing apparatus comprising a storage module configured to store address information of a plurality of computers, on a network, on which a common system environment is to be installed and data to be used to install the common system environment, comprising:
setting each of the plurality of computers in a data receivable state based on the address information read from the storage module;
receiving, from each of the plurality of computers set in the data receivable state by the setting, a data reception ready notification which is transmitted over the network by multicasting to notify data reception ready; and
when the data reception ready notification has been received from each of the plurality of computers by the receiving, transmitting, by multicasting, the data read from the storage module and to be used to install the common system environment to the computers on the network from which the data reception ready notifications have been received.

7. The method of claim 6, wherein after each of the plurality of computers has been set in the data receivable state by the setting, a reception state to receive the data reception ready notification is set.

8. The method of claim 6, wherein when the data reception ready notification has been received from each of the plurality of computers by the receiving, a connection request is sent to the computers on the network from which the data reception ready notifications have been received, and after establishing connection, the data read from the storage module and to be used to install the common system environment is transmitted to the computers on the network which have established the connection.

9. The method of claim 8, wherein when transmitting, by multicasting, the data read from the storage module and to be used to install the common system environment to the computers on the network which have established the connection, address information of a transmission source of the received data reception ready notification is compared with the address information of each of the computers on the network which have established the connection, and if the pieces of address information coincide with each other, the data to be used to install the common system environment is transmitted to the computers on the network which have established the connection.

10. The method of claim 6, wherein when transmitting the data read from the storage module and to be used to install the common system environment to the computers on the network which have established the connection, the data is transmitted to the computers by multicasting.
